(19) United States
(12) Patent Application Publication
(10) Pub. No.: US 2026/0149375 A1
(43) Pub. Date: May 28, 2026

(54) CONTROL CIRCUIT, SWITCHING POWER SUPPLY, AND CONTROL METHOD FOR DC CONVERSION CIRCUIT

(71) Applicant: SHINDENGEN ELECTRIC MANUFACTURING CO., LTD., Tokyo (JP)

(72) Inventors: Kei URUSHIBARA, Saitama (JP); Shigeru HISADA, Saitama (JP); Seiji SHINAGAWA, Saitama (JP)

(21) Appl. No.: 19/118,778

(22) PCT Filed: Aug. 30, 2023
(86) PCT No.: PCT/JP2023/031520

§ 371 Date: Apr. 6, 2025

(30) Foreign Application Priority Data
Oct. 7, 2022 (JP) 2022-162176

(51) Int. Cl. H02M 3/158; H02M 1/00

(52) U.S. Cl. CPC H02M 3/158; H02M 1/0009

(57) ABSTRACT

A control circuit includes: a zero current detection threshold calculation unit configured to calculate a zero current detection threshold Vth1, Vth2 based on a first divided voltage VFB obtained by dividing an output voltage of a direct current conversion circuit; a zero current detection unit configured to detect timing at which a current that flows through an inductor L becomes zero by comparing the zero current detection thresholds Vth1, Vth2 calculated by the zero current detection threshold calculation unit with a voltage VFB based on a voltage applied to a switching element Q; and a switching element drive control unit configured to control turning-on of the switching element Q based on the timing at which the current that flows through the inductor L and is detected by the zero current detection unit becomes zero.

### RELATED APPLICATIONS

The present application is a National Phase of International Application No. PCT/JP2023/031520 filed Aug. 30, 2023, which claims priority to Japanese Application No. 2022-162176, filed Oct. 7, 2022.

### TECHNICAL FIELD

The present invention relates to a control circuit, a switching power supply, and a control method for a direct current conversion circuit.

### BACKGROUND ART

Conventionally, there has been known a switching power supply that includes a boundary-operation-type (Boundary Current Mode Type) direct current conversion circuit (PFC circuit). In the boundary-operation-type direct current conversion circuit, a control is performed such that a switching element is turned on when an inductor current becomes zero.

FIG. 9 Illustrates a Circuit Diagram illustrating a conventional switching power supply 9. As illustrated in FIG. 9, the conventional switching power supply 9 includes a rectifying circuit 10, a direct current conversion circuit 20, a control circuit (IC) 30, an input capacitor C1, and an output capacitor C2. The direct current conversion circuit 20 includes: an inductor L1 through which a current outputted from the rectifying circuit 10 flows; an auxiliary winding L2 of the inductor L1, a switching element Q that changes the increase and the decrease of the current that flows through the inductor L1; and a diode D. One end of auxiliary winding L2, is connected to a ZC terminal of the control circuit 30, and a gate electrode of the switching element Q is connected to a VG terminal of the control circuit 30.

FIG. 10 is a timing chart of a conventional switching power supply. Symbol At indicates a delay time. In the conventional switching power supply 9, a voltage of the auxiliary winding L2 is detected, and timing at which an inductor current becomes zero is detected by comparing a detected auxiliary winding voltage VL with a preset zero current detection threshold Vth. To be more specific, as illustrated in FIG. 10, when a switching element Q is turned off at a point of time t1, a drain current Id suddenly falls, and the auxiliary winding voltage VL, a diode voltage ID and a drain voltage VDS suddenly rise. Then, an auxiliary winding voltage VL that has been increased starts falling at a point of time t2, and timing at which an inductor current becomes zero is detected by detecting timing (a point of time t3) that is below a predetermined threshold Vth, and the switching element is turned on at a point of time t4.

### PRIOR ART LITERATURE

### Patent Literature

Patent Literature

### SUMMARY OF INVENTION

JP-2017-118767

### Technical Problem

FIG. 11A and FIG. 11B are views illustrating drawbacks that a switching power supply described in patent literature 1 has.

Recently, to realize a switching power supply that is more compatible with a design change, a switching power supply provided with a control circuit that detects the following timing has been used. That is, the timing is timing at which an inductor current becomes zero by comparing a voltage based on a voltage applied to a switching element (for example, a voltage obtained by dividing a drain voltage of the element using a resistance) with a threshold instead of using the auxiliary winding of the inductor (for example, see patent literature 1).

However, with such a configuration, in a case where an output voltage is not fully risen at a point of time immediately after startup due to a change in a voltage applied to the switching element depending on an input voltage or an output voltage, there is a possibility that a voltage based on the voltage applied to the switching element does not exceed a threshold voltage (see a waveform on the left side in FIG. 11A) thus giving rise to a drawback that it is difficult to detect timing at which an inductor current becomes zero.

In view of the above-mentioned circumstances, it is an object of the present invention to provide a control circuit capable of detecting timing at which an inductor current becomes zero even in a case where an output voltage has not been risen at such a point of time immediately after startup.

### Solution to Problem

A first control circuit according to the present invention is a control circuit configured to control a direct current conversion circuit having an inductor and a switching element capable of changing an increase and a decrease of a current that flows through the inductor. The control circuit includes: a zero current detection threshold calculation unit configured to calculate a zero current detection threshold based on a first divided volage obtained by dividing an output voltage of the direct current conversion circuit; a zero current detection unit configured to detect timing at which a current that flows through the inductor becomes zero by comparing the zero current detection threshold calculated by the zero current detection threshold calculation unit with a voltage based on a voltage applied to the switching element; and a switching element drive control unit configured to control turning-on of the switching element based on the timing at which the current that flows through the inductor and is detected by the zero current detection unit becomes zero.

A second control circuit according to the present invention is a control circuit configured to control a direct current conversion circuit having an inductor and a switching element capable of changing an increase and a decrease of a current that flows through the inductor. The control circuit includes: a zero current detection threshold acquisition unit configured to acquire a first zero current detection threshold and a second zero current detection threshold set to a voltage lower than the first zero current detection threshold; a zero current detection unit configured to detect timing at which a current that flows through the inductor becomes zero by comparing the first zero current detection threshold and the second zero current detection threshold acquired by the zero current detection threshold acquisition unit with a voltage based on a voltage applied to the switching element; and a switching element drive control unit configured to control turning-on of the switching element based on the timing at which the current that flows through the inductor and is detected by the zero current detection unit becomes zero.

A switching power supply according to the present invention includes: a direct current conversion circuit having an inductor, and a switching element configured to change an increase and a decrease of a current that flows through the inductor; and a control circuit configured to control the direct current conversion circuit. The control circuit is the first control circuit or the second control circuit of the present invention.

A first control method of a direct current conversion circuit according to the present invention is a control method of a direct current conversion circuit configured to control a direct current conversion circuit having an inductor, and a switching element configured to change an increase and a decrease of a current that flows through the inductor. The control method includes: a zero current detection threshold calculation step of calculating a zero current detection threshold based on a first volage obtained by dividing an output voltage of the direct current conversion circuit; a zero current detection step of detecting timing at which a current that flows through the inductor becomes zero by comparing a second voltage based on a voltage applied to the switching element with the zero current detection threshold; and a switching element drive control step of controlling turning-on of the switching element based on the timing at which the current that flows through the inductor is detected by the zero current detection step becomes zero.

A second control method of a direct current conversion circuit according to the present invention is a control method of a direct current conversion circuit configured to control a direct current conversion circuit having an inductor, and a switching element configured to change an increase and a decrease of a current that flows through the inductor. The control method includes: a zero current detection step of detecting timing at which a current that flows through the inductor becomes zero by comparing a voltage based on a voltage applied to the switching element with a first zero current detection threshold and a second zero current detection threshold that are set to a voltage lower than the first zero current detection threshold; and a switching element drive control step of controlling turning-on of the switching element based on the timing at which the current that flows through the inductor is detected by the zero current detection step becomes zero.

### Advantageous Effects of the Present Invention

According to the first control circuit and the switching power supply of the present invention, the control circuit includes: a zero current detection threshold calculation unit configured to calculate a zero current detection threshold based on a first divided volage obtained by dividing an output voltage of the direct current conversion circuit; and a zero current detection unit configured to detect timing at which a current that flows through the inductor becomes zero by comparing the zero current detection threshold calculated by the zero current detection threshold calculation unit with a voltage based on a voltage applied to the switching element. With such a configuration, a zero current detection threshold that corresponds to an output voltage can be set. Accordingly, timing at which an inductor current becomes zero can be detected even in a case where an output voltage has not been risen at such a point of time immediately after startup.

According to the second control circuit and the switching power supply of the present invention, the control circuit includes: a zero current detection threshold acquisition unit configured to acquire a first zero current detection threshold and a second zero current detection threshold set to a voltage lower than the first zero current detection threshold; a zero current detection unit configured to detect timing at which a current that flows through the inductor becomes zero by comparing the first zero current detection threshold and the second zero current detection threshold acquired by the zero current detection threshold acquisition unit with a voltage based on a voltage applied to the switching element. Accordingly, even in a case where an output voltage has not been risen at such a point of time immediately after startup, a voltage based on a voltage applied to the switching element exceeds the second zero current detection threshold and hence, timing at which an inductor current becomes zero can be detected.

In a case (1) an input voltage is low such as a case where the input voltage AC forms a valley, and a voltage based on a voltage applied to the switching element does not exceed a threshold or in a case (2) where an amplitude of resonance voltage is small when an input voltage is high and hence, even after an inductor current becomes zero, the voltage based on the voltage applied to the switching element does not fall below the threshold (see FIG. 11B), there exists a drawback that it is difficult to detect timing at which an inductor current becomes zero. However, according to the second control circuit and the switching power supply of the present invention, even in the above-mentioned case (1), the voltage based on the voltage applied to the switching element exceeds the second zero current detection threshold and hence, timing at which an inductor current becomes zero can be detected. Further, also in the above-mentioned case (2), after an inductor current becomes zero, the voltage based on the voltage applied to the switching element falls below the first zero current detection threshold and hence, timing at which an inductor current becomes zero can be detected.

According to the first control method of a direct current conversion circuit of the present invention, the first control method includes: a zero current detection threshold calculation step of calculating a zero current detection threshold based on a first volage obtained by dividing an output voltage of the direct current conversion circuit; and a zero current detection step of detecting timing at which a current that flows through the inductor becomes zero by comparing a second voltage based on a voltage applied to the switching element with the zero current detection threshold. With such a configuration, a zero current detection threshold that corresponds to an output voltage can be set. Accordingly, timing at which an inductor current becomes zero can be detected even in a case where an output voltage has not been risen at such a point of time immediately after startup.

According to the second control method of a direct current conversion circuit of the present invention, the second control method includes a zero current detection step of detecting timing at which a current that flows through the inductor becomes zero by comparing a voltage based on a voltage applied to the switching element with a first zero current detection threshold and a second zero current detection threshold that is set lower than the first zero current detection threshold. Accordingly, even in a case (1) where an input voltage AC is low such as a case where the input voltage forms a valley, and a voltage based on a voltage applied to the switching element does not exceed a threshold, a voltage based on a voltage applied to the switching element exceeds the second zero current detection threshold and hence, timing at which an inductor current becomes zero can be detected. Further, also in a case (2) where an amplitude of resonance voltage is small when an input voltage is high and hence, even after an inductor current becomes zero, the voltage based on the voltage applied to the switching element does not fall below the second zero current detection threshold (see FIG. 11B), after the inductor current becomes zero, the voltage based on the voltage applied to the switching element falls below the first zero current detection threshold and hence, the timing at which the inductor current becomes zero can be detected.

### BRIEF DESCRIPTION OF DRAWINGS

FIG. 1 is a circuit diagram illustrating a switching power supply 1 according to an embodiment 1.

FIG. 2 is a block diagram illustrating a control circuit 30 according to the embodiment 1.

FIG. 3 is a timing chart in a case where a second divided voltage VDZC exceeds a first zero current detection threshold Vth1 and a second zero current detection threshold Vth2.

FIG. 4 is a timing chart when the second divided voltage VDZC exceeds only the second zero current detection threshold Vth2.

FIG. 5A an FIG. 5B are views illustrating a zero current detection threshold in embodiment 1.

FIG. 6 is a view illustrating an over current detection unit in the embodiment 1.

FIG. 7 is a flowchart illustrating a control method for a direct current conversion circuit according to the embodiment 1.

FIG. 8 is a circuit diagram illustrating a switching power supply 2 according to an embodiment 2.

FIG. 9 is a circuit diagram illustrating a conventional switching power supply 9.

FIG. 10 is a timing chart of the conventional switching power supply.

FIG. 11A and FIG. 11B are views illustrating drawbacks of the switching power supply described in patent literature 1.

### DESCRIPTION OF EMBODIMENTS

Hereinafter, a control circuit, a switching power supply and a control method for a direct current conversion circuit according to the present invention are described based on embodiments illustrated in the drawings. The embodiments described hereinafter are not intended to limit the present invention called for in claims. Further, it is not always the case that all of various embodiments described in the embodiments and combinations of these elements are indispensable as a means to solve the problems of the present invention.

### EMBODIMENT 1

### 1. Configuration of Switching Power Supply 1 According to Embodiment 1

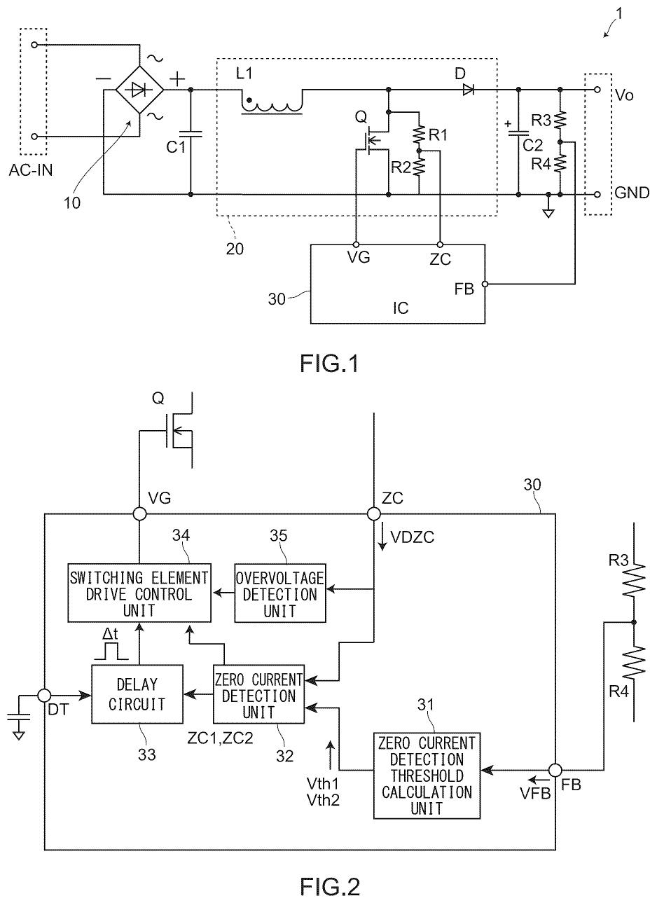

FIG. 1 is a circuit diagram illustrating a switching power supply 1 according to the embodiment 1. As illustrated in FIG. 1, the switching power supply 1 according to the embodiment 1 includes a rectifying circuit 10, a direct current conversion circuit 20, a control circuit 30, an input capacitor C1, an output capacitor C2, and voltage dividing resistors R3, R4.

The rectifying circuit 10 converts alternating current power inputted from an input power supply AC-IN into direct current power. The input capacitor C1 is disposed between the rectifying circuit 10 and the direct current conversion circuit 20. The output capacitor C2 is disposed between the direct current conversion circuit 20 and output terminals (a terminal Vo and a terminal GND). The voltage dividing resistors R3, R4 are connected in series, and divide an output voltage between a terminal Vo and a terminal GND that are output terminals. A node between the voltage dividing resistors R3, R4 is connected with an output voltage detection terminal FB of the control circuit 30.

The direct current conversion circuit 20 includes: an inductor L1 through which a current outputted from the rectifying circuit 10 flows; a switching element Q that changes an increase and a decrease of a current that flows through the inductor L1; a diode D; and voltage dividing resistors R1, R2. The direct current conversion circuit 20 is a boundary-control-type power factor improvement circuit (PFC circuit) that improves power factor by suppressing a harmonic and, at the same time, converts power outputted from the rectifying circuit 10 to direct current power.

One end of the inductor L1 is connected with an output terminal of the rectifying circuit 10 on a +side, and the other end of the inductor L1 is connected with a drain terminal of the switching element Q and an anode electrode of the diode D. In the switching element Q, a drain electrode is connected with the inductor L1 and an anode electrode of the diode D, a source electrode is connected with a ground potential, and a gate electrode is connected with a gate drive terminal VG of the control circuit 30. In the diode D, an anode electrode is connected with the inductor L1 and the drain electrode of the switching element Q, and a cathode electrode is connected with an output terminal Vo.

The voltage dividing resistors R1, R2 are connected in series so as to divide a voltage across the switching element Q. Connecting points of the voltage dividing resistors R1, R2 are connected with a ZC terminal of the control circuit 30.

### 2. Configuration of Control Circuit 30 According to Embodiment 1

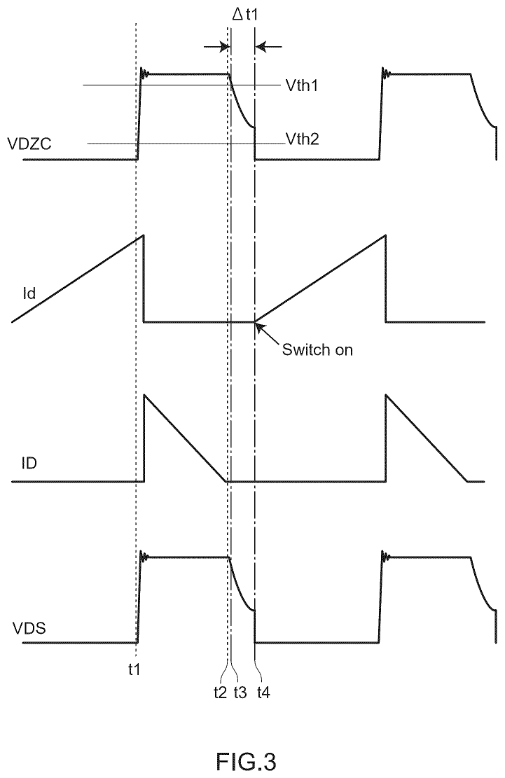

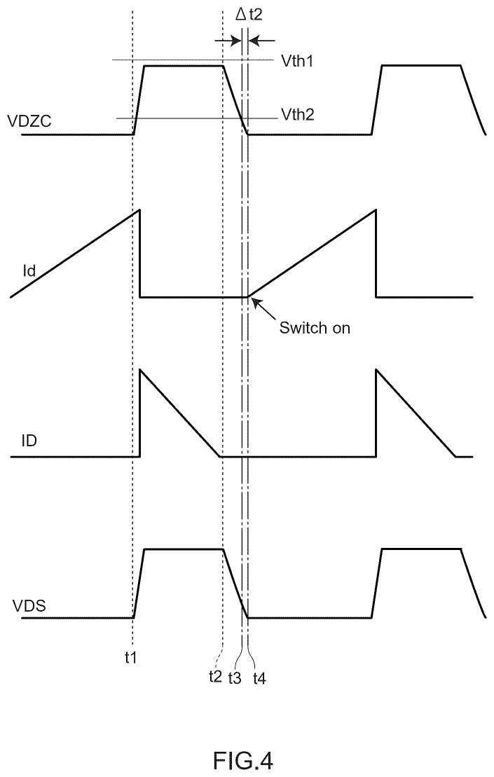

FIG. 2 is a block diagram illustrating the control circuit 30 according to the embodiment 1. FIG. 3 is a timing chart when a second divided voltage VDZC exceeds a first zero current detection threshold Vth1 and a second zero current detection threshold Vth2. FIG. 4 is a timing chart when the second divided voltage VDZC exceeds only the second zero current detection threshold Vth2.

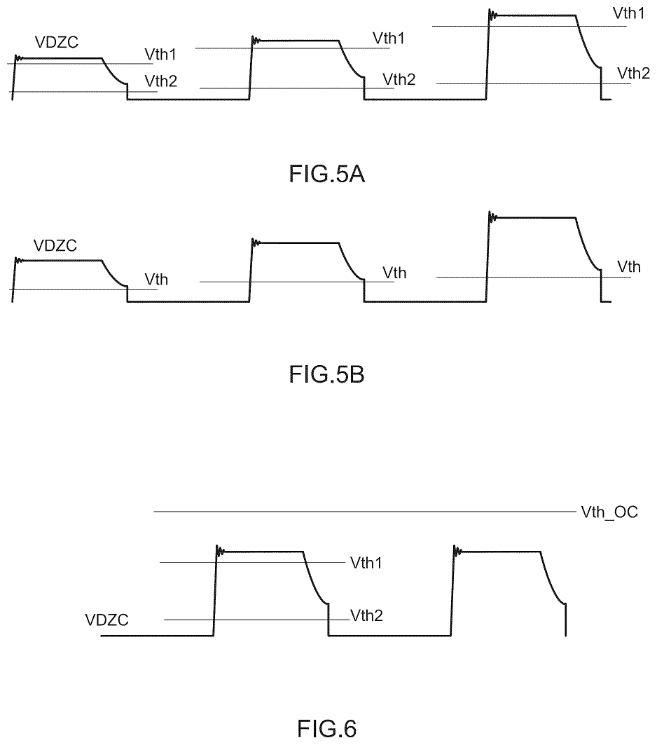

FIG. 5A and FIG. 5B are views illustrating a zero current detection threshold in the embodiment 1. FIG. 5A illustrates a schematic waveform graph indicating the relationship between the second divided voltage VDZC and the zero current detection threshold in respective cases consisting of a case where an output voltage in the embodiment 1 is small (the waveform on the left side in FIG. 5A), a case where the output voltage in the embodiment 1 is intermediate (the waveform at the center in FIG. 5A), and a case where the output voltage in the embodiment 1 is normal (the waveform at the right side in FIG. 5A). FIG. 5B illustrates a schematic waveform graph indicating the relationship between the second divided voltage VDZC and the zero current detection threshold in respective cases consisting of a case where an output voltage in the modification is small (the waveform on the left side in FIG. 5B), a case where the output voltage in the modification is intermediate (the waveform at the center in FIG. 5B), and a case where the output voltage in the modification is normal (the waveform at the right side in FIG. 5B).

As illustrated in FIG. 2, the control circuit 30 according to the embodiment 1 includes a zero current detection threshold calculation unit 31, a zero current detection unit 32, a delay circuit 33, a switching element drive control unit 34, an overvoltage detection unit 35, a gate drive terminal VG, a zero cross detection terminal ZC, and an output voltage detection terminal FB.

The zero current detection threshold calculation unit 31 (also referred to as zero current detection threshold acquisition unit) calculates a zero current detection threshold based on a first divided voltage VFB that divides an output voltage of the direct current conversion circuit 20.

Accordingly, when an output voltage (a first divided voltage) has not been risen as illustrated in the left view and the center view in FIG. 5A, zero current detection thresholds (a first zero current detection threshold Vth1 and a second zero current detection threshold Vth2) of values smaller than those in a normal time are calculated corresponding to the output voltage, and the zero current detection thresholds are gradually increased corresponding to the output voltage. The first zero current detection threshold Vth1 on a high voltage side is more influenced by an output voltage and hence, only the first zero current detection threshold Vth1 may be calculated based on the first divided voltage VFB that divides the output voltage of the direct current conversion circuit 20.

As illustrated in FIG. 2, the zero current detection threshold calculation unit 31 is connected with an output voltage detection terminal FB, and a first divided voltage VFB is inputted to the zero current detection threshold calculation unit 31. The zero current detection threshold calculation unit 31 calculates a first zero current detection threshold Vth1 and a second zero current detection threshold Vth2 that are set to voltages lower than the first zero current detection threshold as the zero current detection threshold value.

As a method of calculating a zero current detection threshold, a suitable method can be used. For example, a zero current detection threshold may be obtained by subtracting a predetermined value from an output voltage (first divided voltage), or a zero current detection threshold may be calculated based on a rate of a magnitude of an output voltage (first divided voltage).

The zero current detection unit 32 detects timing at which a current that flows into the inductor L becomes zero by comparing zero current detection thresholds (first zero current detection threshold Vth1 and the second zero current detection threshold Vth2) calculated by the zero current detection threshold calculation unit 31 with a voltage based on a voltage applied to the switching element Q, to be more specific, a second divided voltage VDZC obtained by dividing a voltage applied to the switching element Q.

The zero current detection unit 32 detects timing at which the VZDC voltage becomes the first zero current detection threshold VTh1 or below as timing that the inductor current becomes zero when the second divided voltage VZDC rises to a voltage value that exceeds both of the first zero current detection threshold Vth1 and the second zero current detection threshold Vth2 along with the turning-off of the switching element Q (see a point of time t3 in FIG. 3).

Further, the zero current detection unit 32 detects timing that the VDZC voltage becomes the second zero current detection threshold Vth2 or below as timing that the inductor current becomes zero when the VZDC voltage is larger than the second zero current detection threshold Vth2 and has been risen only to a voltage value smaller than the first zero current detection threshold Vth1 (see point of time t3 in FIG. 4).

The zero current detection thresholds (first zero current detection threshold Vth1 and second zero current detection threshold Vth2) are inputted to the zero current detection unit 32 from the zero current detection threshold calculation unit 31, and the second divided voltage VDZC is inputted to the zero current detection unit 32 from the ZC terminal.

Zero current detection information is outputted to the switching element drive control unit 34. Zero current detection information ZC1 based on the first zero current detection threshold Vth1 and the zero current detection information ZC2 based on the second zero current detection threshold Vth2 are outputted to the delay circuit 33.

The zero current detection information ZC1 and the zero current detection information ZC2 include information relating to thresholds and information relating to timings at which an inductor current becomes zero.

Based on the zero current detection information ZC1 relating to the first zero current detection threshold Vth1 outputted from the zero current detection unit 32 or based on the zero current detection information ZC2 relating to the second zero current detection threshold Vth2, the delay circuit 33 calculates a delay time from a point of time that the zero current is detected to a point of time that the switching element Q is turned on, and outputs information relating to the delay time to the switching element drive control unit 34.

In the delay circuit 33, a delay time Δt1 from a point of time that a zero current is detected based on the first zero current detection threshold Vth1 to a point of time that the switching element Q is turned on is set longer than a delay time Δt2 from a point of time that a zero current is detected based on the second zero current detection threshold Vth2 to a point of time that the switching element Q is turned on. This is because the time from a point of time t2 at which a drain voltage VDS starts to fall to a point of time t3 at which a zero current is detected is shorter in a case of detecting a zero current based on the first zero current detection threshold Vth1 than in a case of detecting a zero current based on the second zero current detection threshold Vth2. It is desired that the delay time is time set such that the switching element Q is turned on at a valley having an amplitude of a resonance voltage.

The switching element drive control unit 34 controls the turning-on of the switching element Q based on zero current detection information outputted from the zero current detection unit 32, and, based on information relating to the delay time outputted from the delay circuit 33. The switching element drive control unit 34, after the zero current detection information is inputted, turns on the switching element Q after a lapse of the delay time Δt1 or Δt2.

The overvoltage detection unit 35 detects whether or not an output voltage of the direct current conversion circuit becomes an overvoltage by comparing the second divided voltage VDZC obtained by dividing a voltage applied to the switching element Q with a predetermined overvoltage detection threshold Vth_OC (see FIG. 6).

That is, the overvoltage detection unit 35 detects the generation of an overvoltage when the second divided voltage VDZC is the predetermined overvoltage detection threshold Vth_OC.

The overvoltage detection unit 35 receives inputting of the second divided voltage VDZC from a zero cross detection terminal ZC, and outputs overvoltage detection information to the switching element drive control unit 34. When an overvoltage is detected, the switching element drive control unit 34 controls the switching element Q such that an output voltage is decreased.

### 3. Manner of Operation of Control Circuit 30 According to Embodiment 1

Next, the manner of operation of the control circuit 30 according to the embodiment 1 is described.

(1) In a case where the second divided voltage VDZC rises larger than the first zero current detection threshold Vth1 (see FIG. 3), when the switching element Q is turned off at the point of time t1, a zero current detection voltage VDZC (second divided voltage) and a drain voltage VDS suddenly rise, and a predetermined voltage (a voltage larger than the first zero current detection threshold Vth1) is maintained.

At this point of time, a first divided voltage obtained by dividing an output voltage of the switching power supply 1 is inputted to the zero current detection threshold calculation unit 31, and the first zero current detection threshold Vth1 and the second zero current detection threshold Vth2 are calculated (see FIG. 2). Further, at the point of time t1, the drain current Id suddenly falls and becomes zero. Further, the diode current ID suddenly rises, and is gradually lowered after the point of time t1.

Then, when a diode current ID becomes zero at a point of time t2, the zero current detection voltage VDZC and the drain voltage VDS start to fall. At this point of time, in the zero current detection unit 32, a zero current detection threshold (first zero current detection threshold Vthe1) and the second divided voltage VDZC are compared with each other.

Then, when the zero current detection unit 32 detects that the zero current detection voltage VDZC becomes lower than the first zero current detection threshold Vth1 (exceeds the first zero current detection threshold Vth1) at a point of time t3, as illustrated in FIG. 2, the zero current detection unit 32 outputs the zero current detection information ZC1 based on the first zero current detection threshold Vth1 to the delay circuit 33, and the delay circuit 33 calculates a delay time. Information relating to the delay time calculated by the delay circuit 33 is outputted to the switching element drive control unit 34.

The switching element drive control unit 34 outputs a signal that turns on the switching element Q to the gate electrode of the switching element Q at a point of time t4 (see FIG. 3) that is delayed by Δt1 from the point of time t3 where the zero current detection voltage VDZC falls below the first zero current detection threshold Vth1 thus turning on the switching element Q.

Hereinafter, by detecting and controlling the output voltage (first divided voltage) and the switching voltage (second divided voltage) of the switching element Q every cycle, timing of turning on the switching element Q is controlled.

(2) With respect to a case where the second divided voltage VDZC rises to a value smaller than the first zero current detection threshold Vth1 (see FIG. 4), in the same manner as the above-mentioned operation (1), when the switching element Q is turned off at the point of time t1, the zero current detection voltage VDZC and the drain voltage VDS suddenly rise, and the predetermined voltage is maintained. However, although the zero current detection voltage VDZC is larger than the second zero current detection threshold Vth2, the zero current detection voltage VDZC rises to a voltage smaller than the first zero current detection threshold Vth1.

When the diode current ID becomes zero at the point of time t2, the zero current detection voltage VDZC and the drain voltage VDS start falling. At this point of time, in the zero current detection unit 32, the zero current detection threshold (second zero current detection threshold Vth2) is compared with the second divided voltage VDZC.

When the zero current detection unit 32 detects that the zero current detection voltage VDZC becomes lower than the second zero current detection threshold Vth2 (exceeding the second zero current detection threshold Vth2) at the point of time t3, the zero current detection unit 32 outputs zero current detection information ZC2 based on the second zero current detection threshold Vth2 to the delay circuit 33, and the delay circuit 33 calculates the delay time.

Information relating to the delay time calculated by the delay circuit 33 is outputted to the switching element drive control unit 34.

The switching element drive control unit 34 outputs a signal that turns on the switching element Q to a gate electrode of the switching element Q at the point of time t4 that is delayed by Δt2 from the point of time t3 at which the zero current detection voltage VDZC falls lower than the second zero current detection threshold Vth2 via the terminal VG thus turning on the switching element Q.

The timing t3 of the zero current detection based on the first zero current detection threshold Vth1 is detected at the timing earlier than the zero current detection timing t3 based on the second zero current detection threshold Vth2 (see FIG. 3 and FIG. 4). Along with such an operation, the delay time Δt1 after the zero current detection is performed based on the first zero current detection threshold Vth1 becomes longer than the delay time Δt2 after the zero current detection is performed based on the second zero current detection threshold Vth2. Accordingly, time from the point of time t2 to the point of time t4 becomes substantially equal and hence, the fluctuation of switching frequency can be prevented.

### 4. Control Method of Direct Current Conversion Circuit According to Embodiment 1

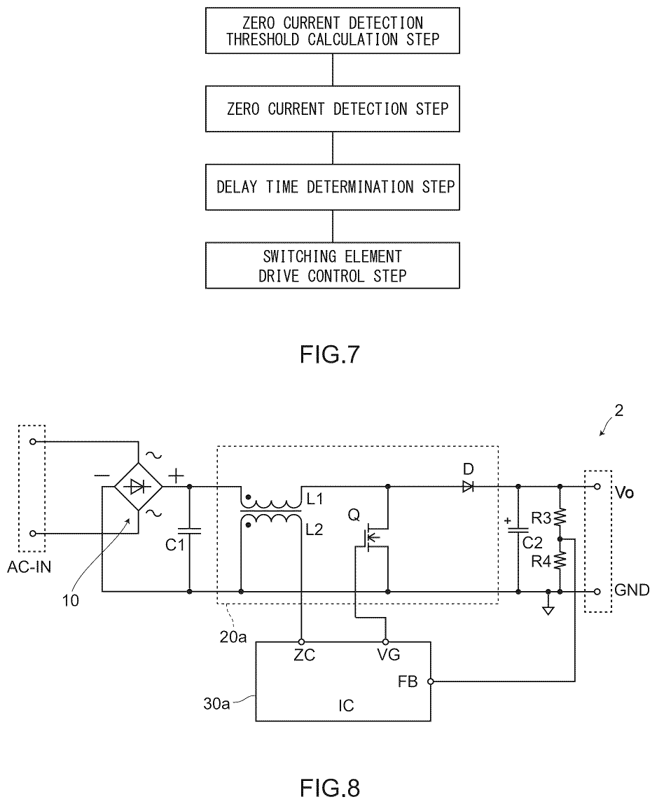

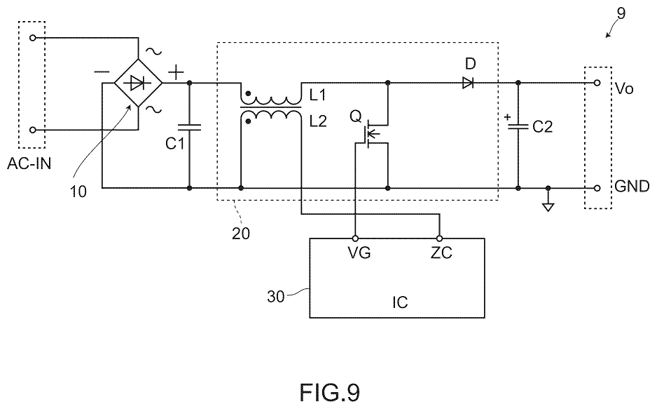

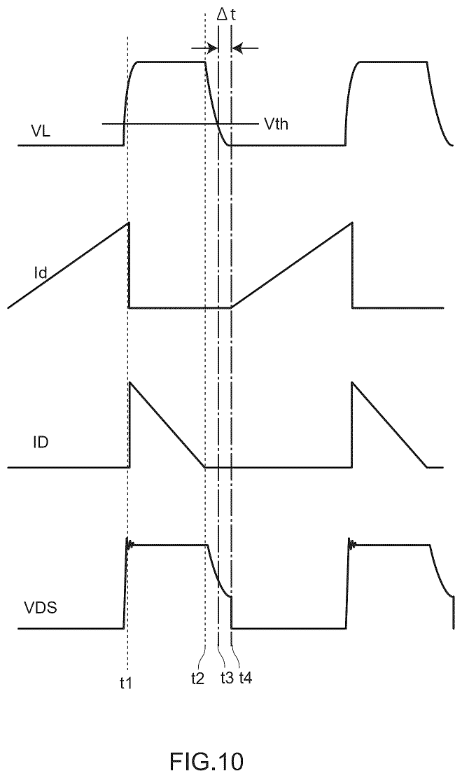

Next, the control method of a direct current conversion circuit according to the embodiment 1 is described. FIG. 7 is a flowchart illustrating the control method of the direct current conversion circuit according to the embodiment 1. The control method of a direct current conversion circuit according to the embodiment 1 is a control method of the direct current conversion circuit that controls the direct current conversion circuit that includes: an inductor L; and a switching element Q that changes the increase and the decrease of a current that flows through the inductor L (see FIG. 7).

The method of controlling the direct current conversion circuit according to the embodiment 1 includes: a zero current detection threshold calculation step of calculating zero current detection thresholds Vth1, Vth2 based on a first divided voltage VFB obtained by dividing an output voltage of the direct current conversion circuit 20; a zero current detection step of detecting timing at which the current that flows through the inductor L becomes zero by comparing the voltage (the second divided voltage VDZC) based on the voltage applied to the switching element Q with the zero current detection thresholds Vth1, Vth2; a delay time determination step of determining a delay time; and a switching element drive control step of controlling the turning-on of the switching element Q based on the timing at which the current that flows through the inductance L detected by the zero current detection step becomes zero.

In the zero current detection step, as the zero current detection threshold, the first zero current detection threshold Vth1 and the second zero current detection threshold Vth2 that is set to a voltage lower than the first zero current detection threshold are used.

### 5. Advantageous Effects Acquired by Control Circuit 30, Switching Power Supply 1 and Direct Current Conversion Circuit According to Embodiment 1

According to the control circuit 30 and the switching power supply 1 of the embodiment 1, the control circuit 30 includes the zero current detection threshold calculation unit 31 that calculates the zero current detection thresholds Vth1, Vth2 based on the first divided voltage VFB obtained by dividing the output voltage of the direct current conversion circuit 20; and the zero current detection unit 32 that detects timing at which a current that flows through the inductor L by comparing the zero current detection threshold Vth1, Vth2 calculated by a zero current detection threshold calculation unit 31 with a voltage applied to the switching element Q. As a result, the zero current detection thresholds Vth1, Vth2 that correspond to the output voltage can be set.

Accordingly, even in a case where an output voltage has not been sufficiently risen such as immediately after startup of the control circuit 30, timing at which an inductor current becomes zero can be detected (see FIG. 5A).

According to the control circuit 30 and the switching power supply 1 of the embodiment 1, the control circuit 30 includes: the zero current detection threshold calculation unit 31 (zero current detection threshold acquisition unit) that calculates the first zero current detection threshold Vth1 and the second zero current detection threshold Vth2 set to a voltage lower than the first zero current detection threshold; and the zero current detection unit 32 that detects timing at which a current that flows through the inductor L becomes zero by comparing the first zero current detection threshold Vth1 and the second zero current detection threshold Vth2 calculated by the zero current detection threshold calculation unit 31 with the voltage based on a voltage applied to the switching element Q.

Accordingly, even in a case where an output voltage has not been sufficiently risen such as immediately after startup of the control circuit 30, the voltage based on the voltage applied to the switching element Q exceeds the second zero current detection threshold Vth2 and hence, timing at which an inductor current becomes zero can be detected.

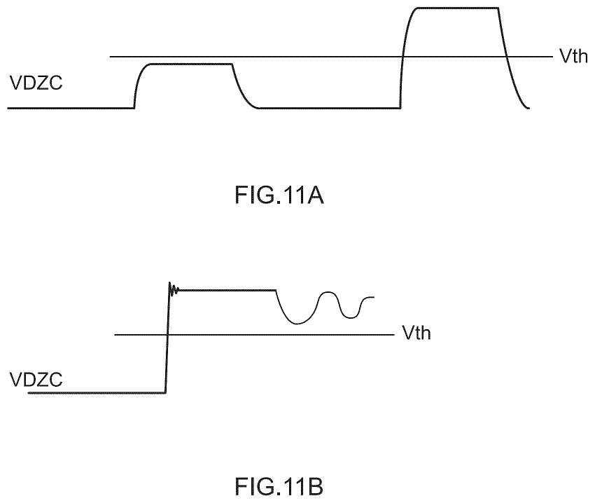

In a case (1) where an input voltage is low, for example, the input voltage AC forms a valley, and a voltage based on a voltage applied to the switching element Q does not exceed a threshold (see waveform on left side in FIG. 11A) or in a case (2) where an amplitude of resonance voltage is small when an input voltage is high and hence, even after an inductor current becomes zero, the voltage based on the voltage applied to the switching element does not fall below the threshold (see FIG. 11B), there exists a drawback that it is difficult to detect timing at which an inductor current becomes zero.

However, according to the control circuit 30 and the switching power supply 1 of the embodiment 1, even in the above-mentioned case (1), the voltage based on the voltage applied to the switching element Q exceeds the second zero current detection threshold Vth2 and hence, timing at which an inductor current becomes zero can be detected.

Further, also in the above-mentioned case (2), after an inductor current becomes zero, the voltage based on the voltage applied to the switching element Q falls below the first zero current detection threshold Vth1 and hence, timing at which an inductor current becomes zero can be detected.

According to the control circuit 30 and the switching power supply 1 of the embodiment 1, the voltage based on the voltage applied to the switching element Q is the second divided voltage VDZC obtained by dividing a voltage across the switching element Q. As a result, it is unnecessary to use an auxiliary winding and hence, the control circuit 30 is applicable without performing designing of a choke coil that is necessary when the auxiliary winding is used whereby the control circuit 30 can easily change its design.

In the control circuit 30 and the switching power supply 1 according to the embodiment 1, the zero current detection is performed using the first zero current detection threshold Vth1 and the second zero current detection threshold Vth2.

However, the first zero current detection threshold Vth1 exhibits a higher voltage and hence, time from the point of time that a voltage starts to rise to the point of time t4 at which the zero current detection is performed becomes shorter in case of the first zero current detection threshold Vth1.

### Accordingly, Assuming That the Delay Time Is

equal between the case that the zero current detection is performed using the first zero current detection threshold Vth1 and the case where zero current detection is performed using the second zero current detection threshold Vth2, switching frequency changes and parameters of output power of the switching power supply change.

To the contrary, according to the control circuit 30 and the switching power supply 1 of the embodiment 1, the delay time from a point of time that the voltage that exceeds (falls below) the first zero current detection threshold Vth1 is detected to a point of time that the switching element Q is turned on is set longer than the delay time from a point of time that the voltage that exceeds (falls below) the second zero current detection threshold Vth2 is detected to a point of time that the switching element Q is turned on.

Accordingly, the time from the point of time t3 that the voltage rises to the point of time that the switching element Q is turned on next time can be adjusted between the case where the zero current detection is performed using the first zero current detection threshold Vth1 and the case where zero current detection is performed using the second zero current detection threshold Vth2.

According to the control circuit 30 and the switching power supply 1 according to the embodiment 1, there is provided the overvoltage detection unit 35 that detects a state that an output voltage of the direct current conversion circuit 20 becomes an overvoltage when the voltage based on the voltage applied to the switching element Q goes beyond the predetermined overvoltage detection threshold Vth_OC. Accordingly, even if a drawback occurs such that the voltage VFB is increased due to a change in resistance value caused by electrolytic corrosion in a divided voltage resistance of a feedback circuit so that the detection of an overvoltage from an output voltage becomes difficult, it is possible to detect an overvoltage safely and with high accuracy even when an overvoltage detection terminal is not added.

According to the control circuit 30 and the switching power supply 1 of the embodiment 1, the direct current conversion circuit 20 is a boundary-control type power factor improvement circuit and hence, a switching loss can be reduced by performing a drive control of turning-on of the switching element Q by detecting the zero current.

According to the control method of the direct current conversion circuit of the embodiment 1, the control method includes: the zero current detection threshold calculation step of calculating the zero current detection thresholds Vth1, Vth2 based on the first divided voltage VFB obtained by diving the output voltage of the direct current conversion circuit 20; and the zero current detection step of detecting timing at which a current that flows through the inductor L becomes zero by comparing the second divided voltage VDZC based on the voltage applied to the switching element Q with the zero current detection thresholds Vth1, Vth2. Accordingly, the zero current detection thresholds Vth1, Vth2 corresponding to the output voltage can be set. Accordingly, even in a case where the output voltage has not been risen immediately after startup of the control circuit 30, it is possible to detect the timing at which the inductor current becomes zero.

### Embodiment 2

FIG. 8 is a circuit diagram illustrating a switching power supply 2 according to the embodiment 2. The switching power supply 2 and a control circuit 30a according to the embodiment 2 have basically substantially the same configuration as the switching power supply 1 and the control circuit 30 according to the embodiment 1. However, the switching power supply 2 and the control circuit 30a according to the embodiment 2 differs from the switching power supply 1 and the control circuit 30 according to the embodiment with respect to a point that a zero current is detected using an auxiliary winding voltage in place of a second divided voltage VDZC (see FIG. 8).

Also in this case, the zero current detection thresholds Vth1, Vth2 are calculated based on an output voltage.

In this manner, the switching power supply 2 and the control circuit 30a according to the embodiment 2 differ from the case of the switching power supply 1 and the control circuit 30 according to the embodiment 1 with respect to the point that the auxiliary winding voltage is used in place of the switching voltage of the switching element. However, in the same manner as the case of the switching power supply 1 and the control circuit 30 according to the embodiment 1, the control circuit 30a includes: a zero current detection threshold acquisition unit that acquires a first zero current detection threshold Vth1 and a second zero current detection threshold Vth2 set at voltages lower than the first zero current detection threshold; and a zero current detection unit that detects timing at which a current that flows an inductor L1 becomes zero by comparing the first zero current detection threshold Vth1 and the second zero current detection threshold Vth2 acquired by the zero current detection threshold acquisition unit with an auxiliary winding voltage.

Accordingly, even in a case where the output voltage has not been risen immediately after startup of the control unit 30, the auxiliary winding voltage exceeds the second zero current detection threshold and hence, it is possible to detect the timing at which the inductor current becomes zero.

The switching power supply 2 and the control circuit 30a according to the embodiment 2 have substantially the same configuration as the switching power supply 1 and the control circuit 30 according to the embodiment 1 with respect to points other than the point that the auxiliary winding voltage is used in place of the second divided voltage VDZC. Accordingly, the switching power supply 2 and the control circuit 30a according to the embodiment 2 have advantageous effects corresponding to advantageous effects amongst all advantageous effects that the switching power supply 1 and the control circuit 30 according to the embodiment 1 acquire.

The present invention has been described based on the above-mentioned embodiments. However, the present invention is not limited to the above-mentioned embodiments. The present invention can be carried out in various modes without departing from the gist of the present invention. For example, the following modifications are also conceivable.

(1) The positions, the connections, the numbers in the above-mentioned respective embodiments (also including the respective modifications (the same being applicable to the modifications described hereinafter) are provided for an exemplifying purpose, and can be changed within a range that the advantageous effects of the present invention are not impaired.

(2) In the above-mentioned respective embodiments, as the zero current detection thresholds, the first zero current detection threshold and the second zero current detection threshold set to voltages lower than the first zero current detection threshold are used. However, the present invention is not limited to such a configuration. The zero current detection threshold Vth1 may be constituted of one zero current detection threshold. Also in this case, the zero current detection threshold calculation unit calculates the zero current detection threshold based on the output voltage (see FIG. 5B).

(3) In the above-mentioned respective embodiments, as the zero current detection threshold, the zero current detection threshold that is calculated based on the first divided voltage obtained by dividing the output voltage of the direct current conversion circuit is used. However, the present invention is not limited such a configuration. As the first zero current detection threshold and the second zero current detection threshold, zero current detection thresholds that are determined in advance may be used (for example, the first zero current detection threshold and the second zero current detection threshold may be acquired from a storage unit disposed inside or outside the zero current detection threshold acquisition unit). Alternatively, as the first zero current detection threshold and the second zero current detection threshold, zero current detection thresholds determined based on parameters other than the first divided voltage may be used.

(4) In the above-mentioned embodiment 1, the zero current is detected using the first divided voltage obtained by diving the output voltage and, in the embodiment 2, the zero current is detected using the auxiliary winding voltage. However, the zero current may be detected by using any other suitable method.

(5) In the above-mentioned respective embodiments, a booster chopper circuit is used as the direct current conversion circuit. However, the present invention is not limited such a configuration. A voltage step-down chopper circuit may be used, and other suitable circuits may be also used.

1. A control circuit configured to control a direct current conversion circuit having an inductor and a switching element capable of changing an increase and a decrease of a current that flows through the inductor, the control circuit comprising:
a zero current detection threshold calculation unit configured to calculate a zero current detection threshold based on a first divided volage obtained by dividing an output voltage of the direct current conversion circuit;
a zero current detection unit configured to detect timing at which a current that flows through the inductor becomes zero by comparing the zero current detection threshold calculated by the zero current detection threshold calculation unit with a voltage based on a voltage applied to the switching element; and
a switching element drive control unit configured to control turning-on of the switching element based on the timing at which the current that flows through the inductor and is detected by the zero current detection unit becomes zero.

2. The control circuit according to claim 1, wherein the zero current detection threshold is constituted of: a first zero current detection threshold; and a second zero current detection threshold set to a voltage lower than the first zero current detection threshold.

3. A control circuit configured to control a direct current conversion circuit having an inductor and a switching element capable of changing an increase and a decrease of a current that flows through the inductor, the control circuit comprising:
a zero current detection threshold acquisition unit configured to acquire a first zero current detection threshold and a second zero current detection threshold set to a voltage lower than the first zero current detection threshold;
a zero current detection unit configured to detect timing at which a current that flows through the inductor becomes zero by comparing the first zero current detection threshold and the second zero current detection threshold acquired by the zero current detection threshold acquisition unit with a voltage based on a voltage applied to the switching element; and
a switching element drive control unit configured to control turning-on of the switching element based on the timing at which the current that flows through the inductor and is detected by the zero current detection unit becomes zero.

4. The control circuit according to claim 1, wherein the voltage based on the voltage applied to the switching element is a second divided voltage obtained by dividing a voltage across the switching element.

5. The control circuit according to claim 3, wherein a delay time from a point of time that a voltage that exceeds the first zero current detection threshold is detected to a point of time that the switching element is turned on is set longer than a delay time from a point of time that a voltage that exceeds the second zero current detection threshold to a point of time that the switching element is turned on.

6. The control circuit according to claim 3, wherein the delay time from a point of time that a voltage that exceeds the first zero current detection threshold is detected to a point of time that the switching element is turned on, and a delay time from a point of time that a voltage that exceeds the second zero current detection threshold is detected to a point of time that the switching element is turned on, are determined such that the switching element is turned on in a valley of a resonance voltage.

7. The control circuit according to claim 1, further comprising an overvoltage detection unit configured to detect that an output voltage of the direct current conversion circuit becomes an overvoltage in a case where the voltage based on the voltage applied to the switching element exceeds a predetermined overvoltage detection threshold.

8. A switching power supply comprising:
a direct current conversion circuit having an inductor, and a switching element configured to change an increase and a decrease of a current that flows through the inductor; and
a control circuit configured to control the direct current conversion circuit, wherein
the control circuit is the control circuit called for in claim 1.

9. (canceled) cm 10. A control method of a direct current conversion circuit configured to control a direct current conversion circuit having an inductor, and a switching element configured to change an increase and a decrease of a current that flows through the inductor, the control method comprising:
a zero current detection step of detecting timing at which a current that flows through the inductor becomes zero by comparing a voltage based on a voltage applied to the switching element with a first zero current detection threshold and a second zero current detection threshold that is set to a voltage lower than the first zero current detection threshold; and
a switching element drive control step of controlling turning-on of the switching element based on the timing at which the current that flows through the inductor is detected by the zero current detection step becomes zero.
